(19) United States
(12) Patent Application Publication
(10) Pub. No.: US 2008/0254162 A1
(43) Pub. Date: Oct. 16, 2008

(54) Electroformed mold and manufacturing method therefor

(75) Inventors: Kimihiro Iimura, Aichi-ken (JP); Muneo Furutani, Aichi-ken (JP); Shoji Araki, Aichi-ken (JP); Nobuyoshi Tanaka, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/076,974

(22) Filed: Mar. 26, 2008

(30) Foreign Application Priority Data
Mar. 28, 2007 (JP) 2007-085101
Mar. 28, 2007 (JP) 2007-085188

(51) Int. Cl. C25D 1/10; B29B 11/06

(52) U.S. Cl. 425/547; 205/70

(57) ABSTRACT

It includes an electroformed shell 6, which has a molding surface 60 and is formed by electroforming processing, a media flow path 2 for circulating a heat medium so as to perform temperature adjustment on the molding surface 60 formed in the electroformed shell 6, a backing member 71 with which the electroformed shell 6 is backed, and media conveying paths 74, respectively provided in an upstream-side end portion 21 and a downstream-side end portion 21, for flowing a heat medium into or out of the media flow path 2. A connecting jig 1 for connecting the media flow path 2 and the media conveying paths 74 is embedded in the electroformed shell 6. The connecting jig 1 includes a cavity portion formed therein, an opening hole having a cross-sectional shape which is substantially the same as the shape of a radially cross-section of the media flow path 2, and a connecting hole having a cross-sectional shape which is substantially the same as the shape of an outside diametrical cross-section of a pipe member 741 constituting each of the media conveying paths 74. The opening hole and the connecting hole are communicated with each other through the cavity portion.

### BACKGROUND OF THE INVENTION

1. Field of the Invention

The present invention relates to an electroformed mold for use in injection molding, and hollow molding, and to a manufacturing method therefor. More particularly, the present invention relates to an electroformed mold that has a molding surface using electroforming techniques and that has a flow path of heat media for heating and cooling.

2. Description of the Invention

Electroformed molds are manufactured by forming molding surfaces through electroforming. The shape of the surface of an object can be transferred with high precision. Thus, in recent years, electroformed molds have been used for molding resin products having precise surface shapes.

Patent Document 1 discloses such an electroformed mold formed, as illustrated in FIG. 27. That is, an electroformed layer 931 serving as a molding surface 90 is formed on a front surface of a porous sheet 91. A pipe member 92 for circulating a heat medium is provided on a rear surface side of the porous sheet 91. The pipe member 92 and the porous sheet 91 are covered with the electroformed layer 932. Thus, the pipe member 92 is fixed to the porous sheet 91. When resin is injected, by circulating high temperature steam in the pipe member 92, the temperature of the molding surface 90 of this electroformed mold is rapidly increased. Upon completion of the injection of resin, by circulating coolant water in the pipe member 92, the molding surface 90 is rapidly cooled. Then, a resin product 95 is taken out of the mold. This electroformed mold is enabled to rapidly heat and cool the molding surface 90. Consequently, molded articles having little temperature unevenness, such as weld marks and sink marks, can be formed.

Also, patent Document 2 discloses such an electroformed mold that has a mold outer frame 1097, and an insert 1095 that is mounted in the mold outer frame 1097 and that constitutes a molding surface, as illustrated in FIG. 28. The molding surface 1971 is formed of a surface of an electroformed shell 1972. The rear surface of the electroformed shell 1972 is backed with a backing member 1973. A flow path of media for temperature adjustment is formed along the boundary between the electroformed shell 1972 and the backing member 1973. Also, another flow path 1975 of media for temperature adjustment is formed in the mold outer frame 1097. When resin is injected, by circulating high-temperature steam through media flow paths 1974 and 1975, the temperature of the molding surface 1971 is rapidly raised. Thus, occurrences of a sink mark and a weld mark in the resin product 1976 are suppressed. Upon completion of injection of resin, the molding surface 1971 is rapidly cooled by circulating water through the media flow paths 1974 and 1975. Then, a resin product 1976 is taken out of the mold. In this electroformed mold, the media flow path 1974 is formed in the vicinity of the molding surface 1971. Accordingly, the molding surface 1971 can rapidly be heated and cooled. A heating time and a cooling time are short. Additionally, there is little temperature unevenness due to weld marks and sink marks.

When such an electroformed mold is manufactured, a master having a transfer surface corresponding to a molding surface is created. Then, by depositing nickel, copper, and the like on the transfer surface of the master, an electroformed shell is formed. A solid body formed of a low-melting-point member for forming a media flow path is provided in a meandering shape on a surface of the electroformed shell. Subsequently, the electroformed shell is backed with a backing member. Thereafter, the solid body is removed by being heated up to a temperature that is higher than the melting point of the low-melting-point member thereby to melt the solid body.

Also, patent Document 3 discloses that a thin plate made of Ni—Cr is disposed on a molding surface, that a cavity forming material is provided on a surface of the thin plate, that a Ni-electroformed layer is formed thereon, and that subsequently, a media flow path is formed between the thin plate and the Ni-electroformed layer by eluting the cavity forming material.

Patent Document 1: JP-A-2004-195758

Patent Document 2: Japanese Patent No. 2656876

Patent Document 3: JP-A-10-29215

Meanwhile, media conveying pipe members for flowing a heat medium into and out of a media flow path of the electroformed shell from and toward the outside are connected to an upstream side and a downstream side of the media flow path, respectively. In a case where the media conveying pipe member is connected to the media flow path, it is considered that, for example, a media flow path 96 is formed of a pipe member 92 disclosed in Patent Document 1, as illustrated in FIG. 29, that the pipe member 92 is connected to a media conveying pipe member 97, and that surfaces of the members are covered with an electroformed layer 932. However, in this case, lower parts of the pipe members 92 and 97 are undercut portions, as indicated by a shaded part shown in FIG. 17. Thus, there is a problem in that an electroformed layer is hardly deposited on the portions represented by the shaded part. Accordingly, there are fears that the media flow path pipe member 92 and the media conveying pipe member 97 cannot surely be connected to each other through the electroformed layer 932, and that a heat medium may leak out of a gap formed in apart of the undercut portion 98, in which no electroformed layer is formed.

Additionally, no electroformed layers are formed between the media flow path pipe member 92 and the porous sheet 91 and between the media conveying pipe member 97 and the porous sheet 91. Accordingly, there is a fear that the media flow path pipe member 92 and the media conveying pipe member 97 cannot surely be fixed to the porous sheet 91.

Also, in the electroformed mold disclosed by Patent Document 1, the steel pipes are provided on the surface of the porous sheet. The surface of each of the steel pipes is covered with an electroformed film. The steel pipes have a certain degree of stiffness. Thus, the media flow paths can be prevented from being deformed by an internal pressure thereof. However, the pipes are difficult to deform, and cannot be provided on a detailed portion of the porous sheet. Even when the pipes are bent, the pitch between every pair of adjacent ones of the pipes is large. Consequently, the pipes cannot be provided at a high density. The temperature adjustment cannot quickly be performed.

In the electroformed mold disclosed by Patent Document 2, the media flow path 1974 is formed in the boundary between the electroformed shell 1972 and the backing member 1973. Consequently, a gap is produced between the boundary surfaces of the electroformed shell 1972 and the backing member 1973 due to the difference in thermal expansion coefficient between the electroformed shell 1972 and the backing member 1973. Thus, there is a fear of leakage of the heat media from the media flow path 1974. Accordingly, the electroformed mold disclosed by Patent Document 2 is poor in durability.

In the electroformed mold disclosed by Patent Document 3, a convex part is formed at a place at which the thin-plate-like solid body is provided. Electroformed metal is intensively deposited on the convex portion. On the other hand, the peripheral border of the solid body is a convex portion. The electroformed shell is difficult to deposit on the concave portion. Thus, the electroformed shell is thin. Consequently, a part of the shell, which is deposited on the peripheral concave portion of the solid body, cannot assure sufficient stiffness. Consequently, there is a fear that the media flow path may be deformed due to in an injection pressure in a molding hole. Also, because the molding surface is formed of a thin plate, it is difficult to form the molding surface having a complicated shape.

### SUMMARY OF THE INVENTION

The invention is accomplished in view of such circumstances. An object of the invention is to provide an electroformed mold enabled to surely connect a media flow path, which is formed in an electroformed shell, to a media conveying path formed outside the electroformed shell, and is to provide a manufacturing method for such an electroformed mold.

Also, the invention is accomplished in view of such circumstances. An object of the invention is to provide an electroformed mold that has a durable media flow path and that excels in cooling characteristics, and to provide a manufacturing method thereof.

To solve the above-described problems, according to an first aspect of the invention, there is provided an electroformed mold having an electroformed shell which has a molding surface and is formed by electroforming processing, a media flow path for circulating a heat medium so as to perform temperature adjustment on the molding surface formed in the electroformed shell, a backing member with which the electroformed shell is backed, and a media conveying path provided outside the electroformed shell and flowing a heat medium into or out of the media flow path. The first electroformed mold is featured in that a connecting jig for connecting the media flow path and the media conveying path is embedded in the electroformed shell, that the connecting jig includes a cavity portion formed therein, an opening hole, exposed from the electroformed shell, having a cross-sectional shape which is substantially the same as the shape of a radially cross-section of the media flow path, and a connecting hole having a cross-sectional shape which is substantially the same as the shape of an outside diametrical cross-section of a pipe member constituting each of the media conveying paths, and that the opening hole and the connecting hole are communicated with each other through the cavity portion.

According to an second aspect of the invention, the electroformed mold is featured in that the connecting jig is provided at least at one of an upstream-side end portion and a lower stream side end portion of the media flow path.

According to a third aspect of the invention, the electroformed mold is featured in that an outer shape of the connecting jig is a non-undercut shape with respect to a bottom surface thereof.

According to a fourth aspect of the invention, the electroformed mold is featured in that an outer shape of the media flow path is a non-undercut shape with respect to a bottom surface thereof.

According to fifth aspect of the invention, there is provided a manufacturing method for an electroformed mold having an electroformed shell which has a molding surface and is formed by electroforming processing, a media flow path for circulating a heat medium so as to perform temperature adjustment on the molding surface formed in the electroformed shell, a backing member with which the electroformed shell is backed, and a media conveying path, provided outside the electroformed shell and flowing a heat medium into or out of the media flow path. The first manufacturing method is featured by including a first electroforming step of forming an electroformed layer on a transfer surface of a master, the transfer surface being shaped according to a shape of the molding surface, a providing step of providing on a surface of the electroformed layer a flow path formation member for forming the media flow path, on which an electrical conductive treatment is performed, and a connecting jig including an opening hole in which the flow path formation member is inserted, a connecting hole, sealed with a sealer, for connecting the media conveying path, and a cavity portion for communicating the opening hole with the connecting hole, a second electroforming step of further forming on a surface of the electroformed layer on which the flow path formation member and the connecting jig are provided, an electroforming layer, and an eluting step of eluting the flow path formation member from the electroformed layer and of forming the media flow path.

According to a sixth aspect of the invention, the manufacturing method is featured in that an exposure portion of the sealer, which is exposed from the connecting hole, is covered with a non-electroformed material.

Further, to achieve the foregoing objects, according to an seventh aspect of the invention, there is provided an electroformed mold having an electroformed shell that has a molding surface and that is formed by electroforming processing, a backing member with which the electroformed shell is backed, and a media flow path that is formed in the electroformed shell and circulates a heat medium so as to adjust the temperature of the molding surface. In the first electroformed mold, the electroformed shell includes a molding layer whose surface serves as the molding surface, a temperature adjustment portion configured so that the media flow path is formed between a first thermally conductive layer and a second thermally conductive layer, which are made of the same material, and a reinforcing layer formed to face the molding layer across the temperature adjustment portion.

According to an eight aspect of the invention, the electroformed mold is featured in that the reinforcing layer is made of the same material as that of the molding layer.

According to a night aspect of the invention, the electroformed mold is featured in that the first thermally conductive layer and the second thermally conductive layer are made of Cu.

According to a ninth aspect of the invention, the electroformed mold is featured in that the reinforcing layer and the molding layer are made of Ni.

According to a tenth aspect of the invention, there is provided a manufacturing method for an electroformed mold including an electroformed shell having a molding surface. A media flow path is formed in the electroformed shell to circulate a heat medium for temperature adjustment. The first manufacturing method is featured by including the steps of sequentially depositing a molding layer and a thermally conductive layer by performing electroforming processing on a transfer surface of a master, the transfer surface of which is shaped according to a shape of the molding surface, and by providing a flow path formation member, on which electrically conducting processing is performed, for forming a media flow path on a surface of the thermally conductive layer, forming an electroformed shell by depositing a thermally conductive layer and a reinforcing layer through further electroforming processing on a surface of the thermally conductive layer, and forming the media flow path by removing the flow path formation member from the electroformed shell.

According to an eleventh aspect of the invention, the first manufacturing method is featured in that the flow path formation member is made of polystyrene.

According to a thirteenth aspect of the invention, the manufacturing method is featured in that the flow path formation member has micro pores provided in a surface thereof.

According to a fourteenth aspect of the invention, the manufacturing method is featured in that the flow path formation member has a non-undercut shape in which an angle formed between a side surface of the flow path formation member and a surface of the electroformed shell is equal to or more than 90° when the flow path formation member is provided on the electroformed shell.

According to the first aspect of the invention, the media flow path provided in the electroformed shell is connected by the connecting jig, which is embedded in the electroformed shell, to the media conveying path provided outside of the electroformed shell. The connecting jig has the opening hole that is opened to the media flow path and that has a cross-sectional shape which is substantially the same as that of a radially cross-section of the media flow path. Thus, the media flow path and the connecting jig are continuously covered with the electroformed shell. Consequently, the connecting jig is surely connected to the media flow path. Additionally, the connecting hole has a cross-sectional shape which is substantially the same as the shape of a radially cross-section of the media conveying path. Thus, the media conveying path can be connected to the connecting hole without a gap. Accordingly, the media flow path can surely be connected to the media conveying path by the connecting jig, so that no heat medium leaks.

According to the second aspect of the invention, the connecting jig is provided at least at one of the upstream-side end portion and the downstream-side end portion of the media flow path. Thus, the heat medium can smoothly be flowed out of and into the media flow path to and from the media conveying path through the connecting jig.

According to the third aspect of the invention, the outer shape of the connecting jig is a non-undercut shape with respect to the bottom surface thereof. In a case where the electroformed layer is formed on a non-flat surface, there is a tendency that a part of the electrode layer, which is formed on each convex part of the non-flat surface, is thick, while a part of the electrode layer, which is formed on each concave part of the non-flat surface. Thus, in a case where the connecting jig has a concave undercut portion, an electroformed metal is difficult to be deposited on the undercut portion. Accordingly, there is a fear that the electroformed layer formed on the undercut portion is thin. Thus, the outer shape of the connecting jig is set to be a non-undercut shape. Consequently, the deposition of the electroformed metal to the connecting jig is enhanced. Consequently, occurrences of failure of formation of the electroformed layer are suppressed. Also, the connecting jig can be surely fixed to the electroformed surface formed on the bottom surface thereof.

According to the fourth aspect of the invention, the shape of the media flow path is a non-undercut shape with respect to a bottom surface thereof. Thus, the electroformed layer surrounding the media flow path is well deposited thereon. Consequently, the media flow path can be further surely connected to the electroformed layer and the connecting jig, which constitute the bottom surface thereof. Accordingly, the leakage of the heat medium can effectively be suppressed.

According to the fifth, the electroformed layer is formed on the surfaces of the flow path forming path and the connecting jig in a state in which the connecting jig is inserted into the opening hole of the connecting jig. Thus, the boundary portion between the flow path formation member and the connecting jig is continuously covered with the electroformed layer having a sufficient thickness. Consequently, in a case where the medium path is formed by eluting the flow path formation member, the media flow path and the connecting jig, are surely connected by the electroformed layer.

Also, the connecting hole of the connecting jig is sealed with the sealer. Thus, the connecting hole of the connecting jig can be prevented from being closed by the electroformed layer. Accordingly, when the second electroforming step is performed, the closed state of the connecting hole can be held. In the subsequent step, the media conveying path can surely be connected to the connecting jig.

According to the sixth aspect of the invention, the exposure portion of the sealer is covered with the non-electroforming material. Thus, no electroformed layer is deposited on the exposure portion of the sealer. Consequently, the sealer can easily be removed from the connecting hole.

As described above, the invention can provide an electroformed mold enabled to surely connect a media flow path, which is formed in an electroformed shell, to a media conveying path formed outside the electroformed shell. The invention can provide also a manufacturing method for such an electroformed mold.

According to the seventh aspect of the invention, the media flow path is formed between the first thermally conductive layer and the second thermally conductive layer and constitute the temperature adjustment portion. The first thermally conductive layer and the second thermally conductive layer are made of the same material. Therefore, the first thermally conductive layer and the second thermally conductive layer are firmly attached to each other. Accordingly, the airtightness of the media flow path is maintained. Because the media flow path is surrounded by the first and second thermally conductive layers having high thermal-conductivity, the temperature of media can quickly be transmitted to the molding surface.

A rib having an amount of projection corresponding to a height of the media flow path is formed along the length direction of the media flow path on the backing member side of a part of the media flow path, in which the electroformed shell is formed. The stiffness of the entire electroformed shell is further increased due to the effect of this rib.

The reinforcing layer is formed opposite to the molding layer across the temperature adjustment portion. Thus, the temperature adjustment portion is reinforced. Consequently, the stiffness of the entire electroformed shell can be assured.

According to the eight aspect of the invention, the reinforcing layer is made of the same material as that of the molding layer. Thus, the temperature adjustment portion is sandwiched between the layers made of the same material. Consequently, the difference in thermal expansion between the molding layer and the temperature adjustment portion is substantially approximate to that in thermal expansion between the reinforcing layer and the temperature adjustment portion. Accordingly, the differences in thermal expansion from the temperature adjustment portion to the side portions are well balanced. The deformation of the electroformed shell is suppressed.

According to the ninth aspect of the invention, the first thermally conductive layer and the second thermally conductive layer are made of Cu. Consequently, the thermal change of the medial flow path can quickly be transmitted to the molding surface.

According to the tenth aspect of the invention, the molding layer and the reinforcing layer are made of Ni. High stiffness can be obtained. Thus, the stiffness of the entire electroformed shell can be further increased. Also, the rate of transfer of the molding layer made of Ni is high. High shape transferability can be achieved.

According to the eleventh aspect of the invention, the electroformed mold can be formed. In a case where the media flow path formation member is formed of a flexibly bendable flow path formation member, the media flowpath can be disposed in a flexible configuration. The media flow path can be formed at high density.

According to the twelfth aspect of the invention, the flow path formation member is made of polystyrene. Thus, the flow path formation member has flexibility. Consequently, the circuit of the flow path can be more flexibly formed. Also, polystyrene has a large number of micro pores. Consequently, the anchoring effect of metal can more effectively be achieved.

According to the thirteenth aspect of the invention, plural micro pores are formed in the surface of the flow path formation member. Thus, metal enters the surface of the flow path formation member. Consequently, the anchoring effect is exerted. Accordingly, metal surely adheres to the surface of the flow path forming portion. Thus, electrical conductivity can be imparted to the entire surface of the flow path formation member.

According to the fourteenth aspect of the invention, the flow path formation member has a non undercut shape in which an angle formed between a side surface of the flow path formation member and a surface of the electroformed shell is equal to or more than 90°. Thus, as compared with a case where the flow path formation member has an undercut shape in which an angle formed therebetween is less than 90°, the deposition of an electroformed metal is enhanced.

As described above, the invention can provide an electroformed mold which has a durable media flow path and excels in cooling characteristics, and can provide also a manufacturing method therefor.

### BRIEF DESCRIPTION OF THE DRAWINGS

FIG. 1 is a cross-sectional view illustrating an electroformed mold according to an embodiment 1 of the invention.

FIG. 2 is a perspective view illustrating a connecting jig according to the embodiment 1.

FIGS. 3A and 3B are perspective views illustrating connecting jigs used according to the invention. FIG. 3A illustrates a cross-sectionally trapezoidal-shaped connecting jig in which a pair of opposed side surfaces are parallel to each other and in which another pair of side surfaces are inclined to the bottom surface thereof. FIG. 3B illustrates another cross-sectionally trapezoidal-shaped connecting jig in which two pairs of opposed side surfaces are inclined to the bottom surface thereof.

FIG. 4 is a plan view illustrating the plane configuration of media flow paths according to the invention.

FIG. 5 is a cross-sectional view illustrating a master according to the invention.

FIG. 6 is an explanatory view illustrating a case where a molding layer and a first thermally conductive layer are formed on a transfer surface of the master.

FIG. 7 is an explanatory view, continued from FIG. 6, illustrating a case where a flow path formation member is provided on a surface of the first thermally conductive layer.

FIG. 8 is a perspective view illustrating a flow path formation member according to the embodiment 1.

FIGS. 9A and 9B are perspective explanatory views illustrating flow path formation members used according to the invention. FIG. 9A illustrates a case where the flow path formation member is cross-sectionally rectangular-shaped. FIG. 9B illustrates a case where the flow path formation member is cross-sectionally trapezoidal-shaped.

FIG. 10 is an explanatory view illustrating a case where a connecting jig is provided at an end portion of the flow path formation member according to the embodiment 1.

FIG. 11 is an explanatory view, continued from FIG. 10, illustrating a case where a second thermally conductive layer and a reinforcing layer are formed on surfaces of the flow path formation member and the connecting jig.

FIG. 12 is an explanatory view, continued from FIG. 11, illustrating a case where a screw and the flow path formation member are removed.

FIG. 13 is a cross-sectional view illustrating a case where an electroformed shell having a media flow path provided therein is formed.

FIG. 14 is an explanatory view illustrating a method of backing the electroformed shell with a backing member.

FIG. 15 is an explanatory view, continued from FIG. 14, illustrating a method of backing the electroformed shell with the backing member.

FIG. 16 is a cross-sectional view illustrating an electroformed mold according to Embodiment 2.

FIG. 17 is a cross-sectional view illustrating an electroformed shell according to Embodiment 2.

FIG. 18 is a cross-sectional view illustrating a master used in a manufacturing method for the electroformed mold according to Embodiment 2.

FIG. 19 is a method of forming an electroformed shell on the master according to Embodiment 2.

FIG. 20 is an explanatory view, continued from FIG. 19, illustrating the method of forming the electroformed shell.

FIG. 21 is an explanatory view, continued from FIG. 20, illustrating the method of forming the electroformed shell.

FIG. 22 is an explanatory view, continued from FIG. 21, illustrating a method of backing the electroformed shell with a backing member.

FIG. 23 is an explanatory view, continued from FIG. 22, illustrating a method of backing the electroformed shell.

FIG. 24 is a perspective explanatory view illustrating a flow path formation member according to Embodiment 2.

FIGS. 25A and 25B are perspective explanatory views illustrating flow path formation members used in the electroformed mold according to the invention. FIG. 25A illustrates a case where the flow-path formation member is cross-sectionally rectangular shaped. FIG. 25B illustrates a case where the flow path formation member is cross-sectionally trapezoid shaped.

FIG. 26 is plan explanatory view illustrating a media flow path according to Embodiment 2.

FIG. 27 is a cross-sectional view illustrating a electroformed shell of a related electroformed mold.

FIG. 28 is a cross-sectional view illustrating a related electroformed shell.

FIG. 29 is a perspective explanatory view illustrating a media flow path connected to a media conveying pipe member of the related electroformed mold.

### DESCRIPTION OF THE PREFERRED EMBODIMENTS

### Embodiment 1

An electroformed mold according to the invention has a media flow path formed in the electroformed shell. Preferably, the shape of a cross-section of the media flow path is a non undercut shape, such as a semicircle, a rectangle, a square, and a trapezoid. The non-undercut shape is defined as a shape formed so that when the media flow path is projected from above, there is no lower part thereof, which is hidden by an upper part thereof and cannot be seen from above. In a case where the shape of the media flow path is a non-undercut shape, the deposition of the electroformed metal can be enhanced, as compared with a case where the shape of the media flow path is an undercut shape so that when the media flow path is projected from above, there is a part thereof, which is hidden by an upper part thereof and cannot be seen from above.

Preferably, the width of the media flow path ranges 5 mm to 15 mm. In a case where the width of the media flow path is less than 5 mm, an amount of flow of the heat medium is small. Consequently, there is a fear that the adjustment of temperature of the media flow path cannot quickly be achieved. In a case where the width of the media flow path exceeds 15 mm, there is a fear that the media flow path may be deformed by a pushing force of a molding material, which is applied to the molding surface.

The connecting jig is connected to the media flow path. The connecting jig is a jig for connecting the media conveying path, which is embedded in the backing member, to the media flow path formed in the electroformed shell.

The connecting jig has an opening hole having a cross-sectional shape which is substantially the same as the shape of a radially cross-section of the media flow path, a connecting hole having a cross-sectional shape which is substantially the same as the shape of an outside diametrical cross-section of the pipe member, and a cavity portion which communicates the opening hole and the connecting hole with each other. The connecting jig is embedded in the electroformed shell. The connecting hole is exposed to the outside of the electroformed shell.

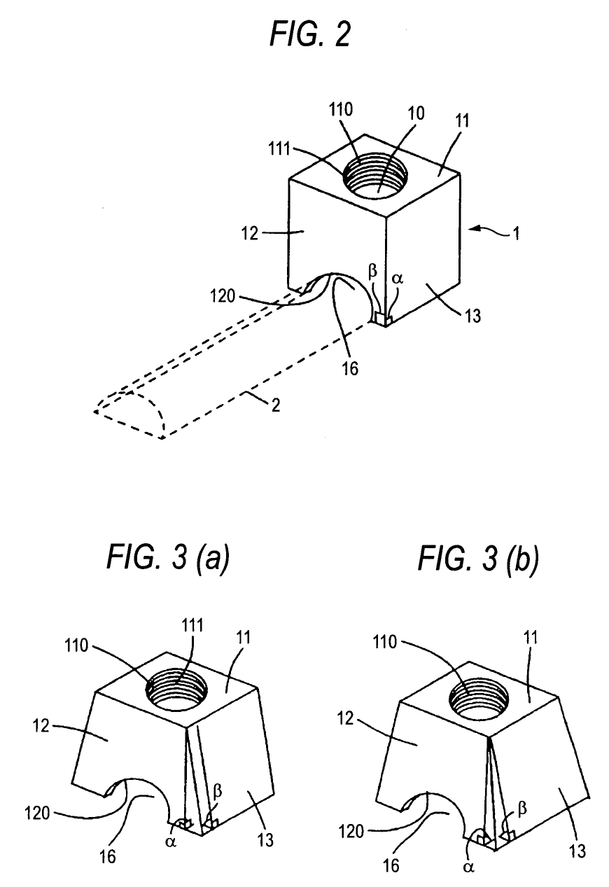

The outer shape of the connecting jig is, for example, a non undercut shape with respect to the bottom surface thereof. Preferably, the shape of such a connecting jig is a shape adapted so that the top surface of the connecting jig is parallel to the bottom surface thereof. Examples of such a shape are a rectangular parallelepiped in which opposed side surfaces of each of two pairs 12, 13 are parallel to each other (see FIG. 2), a cross-sectionally trapezoid-shaped solid in which opposed surfaces of one pair 12 are parallel to each other and in which opposed surfaces of the other pair 13 are inclined to the bottom surface 16 (see FIG. 3A), and a cross-sectionally trapezoid-shaped solid in which opposed side surfaces of each of two pairs 12, 13 are inclined to the bottom surface 16 (see FIG. 3B).

Preferably, the connecting jig is made of a heat resistant material such as a metal including Cr and Fe. In a case where the connecting jig is made of a metallic material, the connecting jig is formed by, for example, machining.

The opening hole and the connecting hole can be formed in any surface of the connecting jig. For example, the opening hole is formed in a side surface of the connecting jig, while the connecting hole is formed in the top surface of the connecting jig. Alternatively, the opening hole and the connecting jig can be formed so that the opening hole is formed in a side surface of the connecting jig, while the connecting hole is formed in another side surface of the connecting jig.

By electroforming processing, the electroformed shell is formed. When electroforming processing is performed, a target metal is deposited on the transfer surface of the master by utilizing an electrochemical reaction and feeding electric current in an electrolyte solution containing metal ions.

The electroformed shell has a molding layer constituting a molding surface. Preferably, the molding layer is made of a material having high transferability and stiffness, for example, Ni.

Preferably, the temperature adjustment portion including the first thermally conductive layer, the second thermally conductive layer, and the media flow path formed between the first and second thermally conductive layers is provided on a trailing side opposite to the molding surface of the molding layer. In this case, the temperature of a heat medium flowing through the media flow path is efficiently transmitted to the molding surface. Thus, temperature adjustment can quickly be achieved.

Preferably, the first and second thermally conductive layers are made of the same material. In this case, the first and second thermally conductive layers are firmly and closely attached to each other. The heat medium is suppressed from leaking from the media flow path formed between the first and second thermally conductive layers. Preferably, the first and second thermally conductive layers are made of, for example, Cu which is a material having high thermal conductivity.

Preferably, the reinforcing layer is formed on the trailing side opposite to the molding layer of the temperature adjustment portion, that is, the side on which the backing member is provided. In this case, the temperature adjustment portion is reinforced, so that the sufficient stiffness of the entire electroformed shell can be assured.

Preferably, the reinforcing layer is made of the same material as that of the molding layer. In this case, the temperature adjustment portion is sandwiched by the layers made of the same material. Accordingly, the thermal expansion difference between the molding layer and the temperature adjustment portion is nearly approximated to that between the reinforcing layer and the temperature adjustment portion. Consequently, the thermal expansion difference is balanced between both sides of the temperature adjustment portion. The deformation of the electroformed shell is suppressed.

By providing the flow path formation member on which an electrically conductive treatment is performed on a surface of the electroformed layer and by eluting the flow path formation member after the electroforming, the flow path is formed. Preferably, the flow path formation member is a flexibly bendable flow path formation member. In this case, flexibility in forming the circuit of the media flow path is increased.

Preferably, the flow path formation member has micro pores in a surface thereof. This is because the electrical conductive member is surely attached to a surface of the flow path formation member due to the anchoring effect of the micro pores when the electrical conductive treatment is performed on the flow path formation member. When micro pores are formed in the surface thereof, a foamed material is mixed into a resin material so as to foam. Alternatively, by surface polishing, the surface of the flow path formation member is roughened. The flow path formation member can be elongated like, for example, a rope either by using a monofilament or by knitting a plurality of filaments.

The flow path formation member is made of a material that can be solved by a solvent or by high heat. Preferably, the flow path formation member is made of polystyrene. Because polystyrene has a large number of fine pores, electrically conductive film is surely attached to the surface of the flow path formation member due to the anchoring effect.

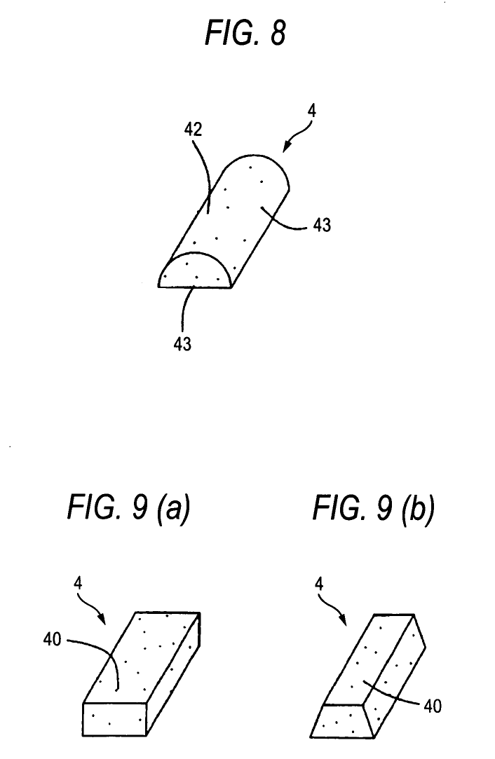

Preferably, the flow path formation member having a part formed into a non-undercut shape with respect to the electroformed layer serving as the bottom surface thereof. In this case, a boundary portion between the flow path formation member and the electroformed layer serving as the bottom surface of the flow path formation member has a non undercut shape when the second electroforming step is performed. Thus, the electroformed metal is relatively easily deposited on the boundary portion. Consequently, the flow path formation member, and the electroformed layer serving as the bottom surface thereof are continuously covered with the electroformed layer formed in the second electroforming step. Accordingly, when by eluting the flow path formation member the media flow path is formed, the entire media flow path is covered with the electroformed layer. Thus, the heat medium can be suppressed from being leaked from the media flow path. Examples of the non-undercut shape of the flow path formation member are a semicircle (see FIG. 8), a rectangle (see FIG. 9A), and a trapezoid (see FIG. 9B).

An electrical conductive treatment is performed on the flow path formation member so as to deposit an electroformed layer on a surface of the flow path formation member. When the flow path formation member is eluted, a media flow path surrounded by the electroformed layer is formed on a place on which the flow path formation member has been provided. The electrical conductive treatment is, for example, to apply silver paste, which is obtained by dispersing silver powder in binder, onto the surface of the flow path formation member or to perform a silver mirror process of depositing silver by a silver mirror reaction.

The connecting jig is provided at the flow path formation member. The connecting jig is provided at least at one of an upstream-side portion, a downstream-side portion and a middle portion between the upstream-side portion and the downstream-side portion of the flow path formation member. The connecting hole formed in the connecting jig is sealed with a metallic sealer containing Cr and/or Fe. Preferably, an exposure portion exposed from the connecting hole of the sealer is covered with a non-electroformed material. No electroformed metal is deposited on a part covering the non-electroformed material. Thus, the sealer can easily be removed after the second electroforming step. The non-electroformed material is, for example, wax and is formed like a sheet or paste.

Preferably, the sealer has a fitting portion having substantially the same shape as that of the connecting hole. In this case, the sealer is surely held in the connecting hole. For example, in a case where the connecting portion has a threaded part, the fitting portion has a threaded shape corresponding to the threaded portion.

The connecting jig is provided on the electroformed layer so that the flow path formation member is inserted in the opening hole. In this state, an electroformed layer is further formed. Then, the electroformed layer is formed on the surfaces of the flow path formation member and the connecting jig.

Subsequently, the flow path formation member is eluted by a solvent as acetone or by high heat. Thus, a media flow path is formed. Also, the sealer is removed from the connecting jig. And, the connecting hole is opened therein.

The media conveying member to be connected to the connecting hole is formed of, for example, a pipe member and is embedded in the backing member. The pipe member is made of a heat resistant resin or a metal. Preferably, an end connection of the pipe member, at which the pipe member is connected to the connecting jig, is threaded. Also, preferably, the connecting hole of the connecting jig has a threaded portion that can be screwed into the end connection of the pipe member. In this case, the pipe member can be more surely connected to the connecting jig by being screwed to the connecting jig.

The backing member, with which the electroformed shell is backed, is shaped according to the shape of the rear surface of the electroformed shell and is provided on the rear surface thereof. The material of the backing member is, for example, a metallic material, such as a heat resistant resin, a cement, or aluminum, which can include an electrically conductive material, such as aluminum powder, fibers, such as a carbon fiber, and a reinforcing material, such as a sheet.

A backing surface of the backing member, with which the electroformed shell is backed, can be formed by, for example, electrical-discharging. Alternatively, the backing surface of the backing member, with which the electroformed shell is backed, can be formed by pouring the molten material of the backing member onto a surface opposite to the molding surface of the electroformed shell.

The electroformed mold is used for molding, for example, resin products. The electroformed mold can freely adjust the temperature thereof by circulating a heat medium in the media flow path. Thus, the electroformed mold is used suitably for molding products having various shapes, such as a thin shape, an elongated shape, and a fine design-surface shape, and for preventing the formation of weld marks and sink marks.

An embodiment 1 of the invention is described below with reference to the accompanying drawings.

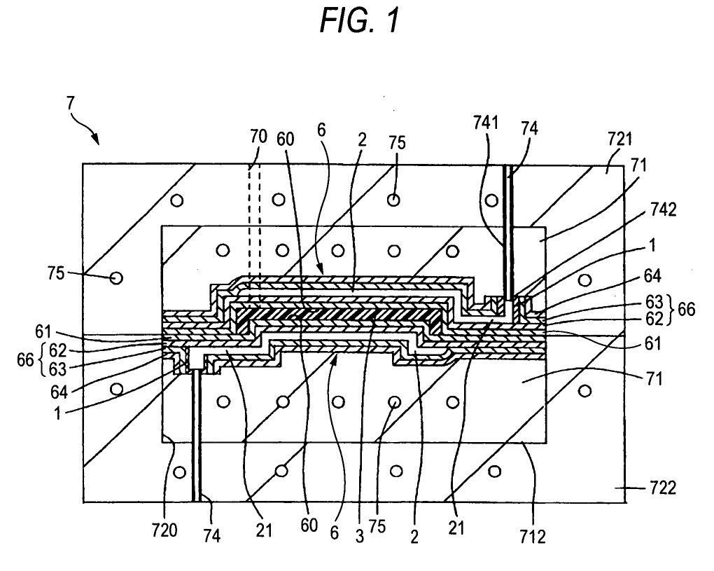

As illustrated in FIGS. 1 and 2, an electroformed mold 7 according to the present embodiment includes an electroformed shell 6 that has a molding surface 60 and that is formed by electroforming processing, a media flow path 2 that is formed in the electroformed shell 6 and circulates a heat medium so as to adjust the temperature of the molding surface 60, a backing member 71 with which the electroformed shell 6 is backed, and a media conveying path 74 that is embedded in the backing member 71 and is provided at each of upstream-side and downstream-side end portions 21 of the media flow path 2 to flow a heat medium into or out of the media flow path 2.

The connecting jig 1 for connecting the media flow path 2 and the media conveying path 74 to each other is embedded in the electroformed shell 6. As illustrated in FIGS. 1 and 2, the connecting jig 1 includes a cavity portion 10 formed therein, an opening hole 120 having a cross-sectional shape which is substantially the same as the shape of a radially cross-section of the media flow path 2, and a connecting hole 110 having a cross-sectional shape which is substantially the same as the shape of an outside diametrical cross-section of a pipe member 741 constituting each of the media conveying paths 74. The opening hole 120 and the connecting hole 110 are communicated with each other through the cavity portion 10.

The shape of the connecting jig 1 is a rectangular parallelepiped, and the bottom portion 16 thereof is opened. An angle α formed between the bottom portion 16 and one of adjacent side surfaces 12 and 13, and an angle β formed between the bottom portion 16 and the other of adjacent side surfaces 12 and 13 are right angles. The opening hole 120 is formed in one of the side surfaces 12 of the connecting jig 1. The connecting hole 110 is opened in the top surface 11. The opening hole 120 is opened like a semicircle. The shape of a cross-section of the opening hole 120 is substantially the same as that of a cross-section of the end portion 21 of the media flow path 2. The connecting hole 110 is opened like a circle. A threaded portion 111 is formed in the inner wall surface of the connecting hole 110. The connecting hole 110 is opened in the electroformed in the electroformed shell 6 and is screwed into the threaded portion 742 of the pipe member 741 embedded in the backing member 71.

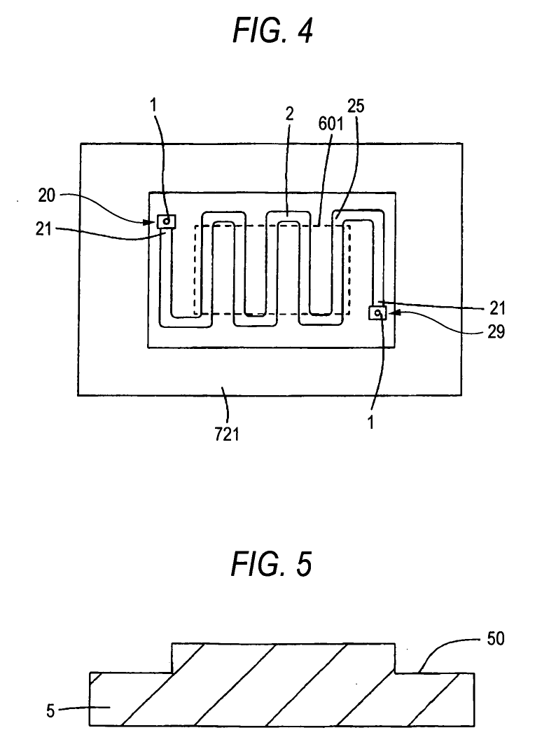

As illustrated in FIG. 4, the media flow path 2 is provided in the electroformed layer 6 in a meandering shape. The media conveying path formed of the pipe member is connected through the connecting jig 1 to both end portions 21 of the media flow path 2, which correspond to an upstream side 20 and a downstream side 29 thereof, respectively.

As illustrated in FIG. 1, the electroformed layer 6 includes a molding layer 61 on which the molding surface 60 is formed, a temperature adjustment portion 66 that has a first thermally conductive layer 62 and a second thermally conductive layer 63 so that the media flow path 2 is formed between both the thermally conductive layers 62 and 63, and a reinforcing layer 64 formed opposite to the molding layer 61 across the temperature adjustment portion 66. The first thermally conductive layer 62 and the second thermally conductive layer 63 are made of the same material and are electroformed layers made of Cu that is high in thermal conductivity. The molding layer 61 and the reinforcing layer 64 are made of the same material and are electroformed layers made of Ni that is high in stiffness and transfer rate. The thicknesses of the molding layer 61, the first thermally conductive layer 62, the second thermally conductive layer 63, and the reinforcing layer 64 are 3 mm, 4 mm, 4 mm, and 3 mm, respectively. The shape of a cross-section of the media flow path 2 is a semicircle. The diameter of the cross-section of the media flow path 2 is 8 mm. The backing member 71 is made of aluminum.

The electroformed mold 7 has an upper-mold 721 and a lower mold 722. A cavity 720 is formed between the upper-mold 721 and the lower-mold 722. Two electroformed shells 6 backed with the backing member 71 are provided in the cavity 720 as cores. One of the two electroformed shells 6 constitutes the front surface of a resin product 3, while the other electroformed shell 6 constitutes the rear surface of the resin product 3. Metallic pipes 75 for circulating temperature adjustment heat media are embedded in each of the upper-mold 721, the lower-mold 722, and the backing member 71.

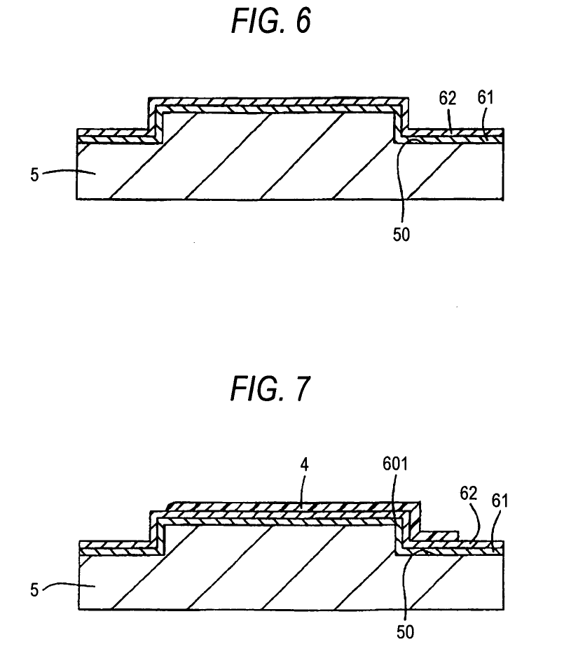

Next, a manufacturing method for an electroformed mold is described below. First, as illustrated in FIG. 5, a master 5 having a transfer surface 50 shaped according to the shape of the molding surface 60 is prepared. The master 5 is made of an epoxy resin material to which electrical conductivity is imparted. As illustrated in FIG. 6, by performing electroforming processing on the master, 5 the molding layer 61 and the first thermally conductive layer 62 are sequentially formed. By immersing the master 5 in an electrolyte solution containing Ni-ions and Cu-ions and also feeding electric current to the solution, electroforming processing is performed. Thus, target metal is deposited on the transfer surface 50. Consequently, the molding layer 11 that is made of Ni and the thermally conductive layer 12 that is made of Cu, are sequentially formed.

Next, as illustrated in FIG. 8, the flow path formation member 4 for forming a media flow path is prepared. A cross-sectionally semicircular-shaped monofilament, which is 8 mm in diameter and is made of polystyrene, is used as the flow path formation member 4. When by performing extrusion molding on polystyrene the flow path formation member 4 is formed, a large number of micro pores 40 are formed in a surface of the flow path formation member 4. Silver paste obtained by dispersing silver powder in binder is applied to the flow path formation member 4. Thus, electrical conductivity is imparted to a surface of the flow path formation member 4. At that time, silver paste is surely attached to the flow path formation member 4 due to the anchoring effect of the micro pores 40.

Next, as illustrated in FIG. 7, the flow path formation member 4 is disposed on the first thermally conductive layer 62. As illustrated in FIGS. 7 and 8, the flow path formation member 4 is cross-sectionally semicircular-shaped. A straight part 43 of the flow path formation member 4 is caused to abut against the first thermally conductive layer 62. A cross-sectionally semicircular-arc-part 42 is disposed to be directed upwardly. At that time, as illustrated in FIG. 4, the flow path formation member 4 is disposed on the entire first thermally conductive layer 62 in a meandering shape so that the straight parts are placed at predetermined intervals.

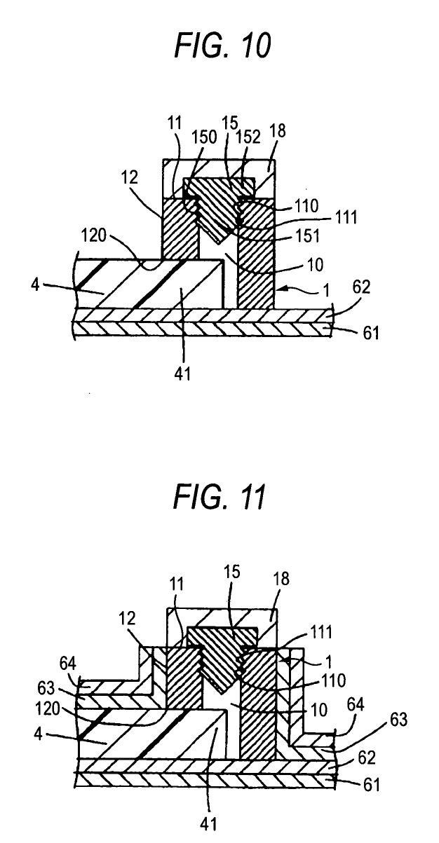

Next, the metallic connecting jig 1 is prepared, which has the opening hole 120 that has a radial cross-section whose shape is substantially the same as that of a radial cross-section of the flow path formation member 4, as illustrated in FIG. 2, the connecting hole 110 that has a radial cross-section whose shape is substantially the same as that of an outer diametrical cross-section of the pipe member 741, and the cavity portion 10 for connecting the opening hole 120 with the connecting hole 110. The connecting hole 110 is a circular hole. A threaded portion 111 is formed in the inner wall of the connecting hole 110. Next, as illustrated in FIG. 10, a metallic screw 15 serving as a sealer having a fitting portion 151 is inserted into the connecting hole 110 of the connecting jig 1. The fitting portion 151 of the screw 15 has a threaded part 150. The threaded part 150 is screwed into the threaded portion 111 of the connecting hole 110. Ahead portion 152 of the screw 15 is exposed from the connecting hole 110. The head portion 152 and the top surface 11 of the connecting jig 1 are covered with a wax sheet 18. Next, in a state in which an end portion 41 of the flow path formation member 4 is inserted into the opening hole 120 of the connecting jig 1, the connecting jig 1 is provided on the surface of the first thermally conductive layer 62.

Next, as illustrated in FIG. 11, the second thermally conductive layer 63 made of Cu and the reinforcing layer 64 made of Ni are additionally and sequentially formed on the first thermally conductive layer 62, on which the flow path formation member 4 and the connecting jig 1 are provided, by electroforming processing. The flow path formation member 4 is covered with the silver paste and has electrical conductivity. Thus, the second thermally conductive layer 63 and the reinforcing layer 64 are formed also on the flow path formation member 4. Additionally, because the connecting jig 1 is made of a metal, the second thermally conductive layer 63 and the reinforcing layer 64 are formed also on a part of the connecting jig 1, which is not covered with the wax sheet 18. Thus, the electroformed shell 6 including the molding layer 61, the first thermally conductive layer 62, the second thermally conductive layer 63 and the reinforcing layer 64 is formed on the surface of the master 5.

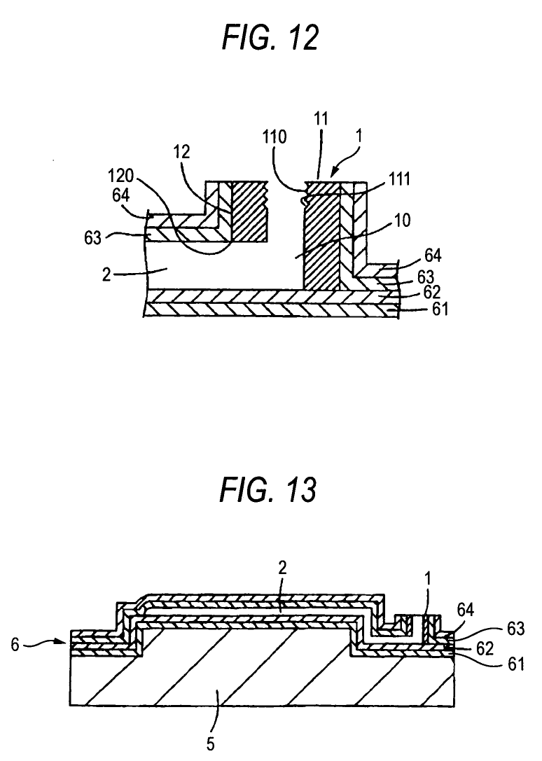

Next, as illustrated in FIGS. 12 and 13, the wax sheet 18 is removed. The screw 15 is removed from the connecting hole 110. Then, the flow path formation member 4 is eluted by the solvent as acetone. Thus, the media flow path 2 is formed.

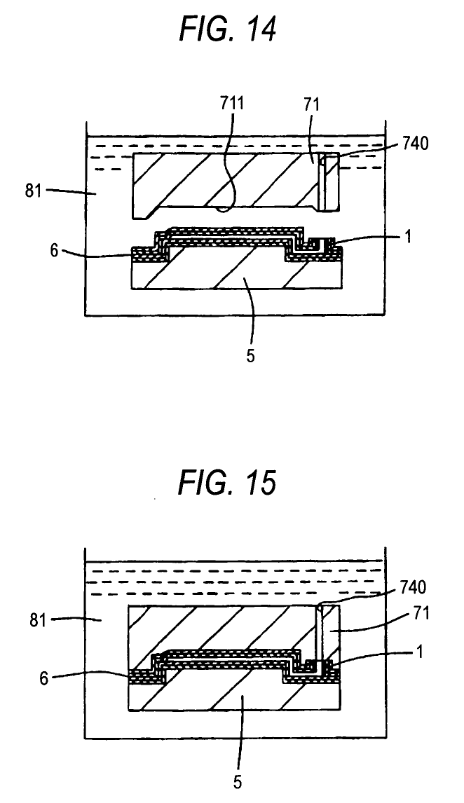

Next, as illustrated in FIG. 14, surface processing (e.g., cutting processing) is performed on the surface of the backing member 71 made of aluminum, in which a media conveying hole 740 is formed, so that the surface of the backing member 71 approximately corresponds to the shape of the surface of the electroformed shell 6. Subsequently, the master 5, in which the electroformed shell 6 is formed, and the backing member 71 are immersed in oil 81. Then, in a state in which the processed surface 711 of the backing member 71 is opposed to the electroformed shell 6, electric discharge processing is performed in the oil 81. Subsequently, as the distance between the processed surface 711 and the electroformed shell 6 is decreased, electric discharge occurs between the electroformed shell 6 and the processed surface 711. Thereafter, as illustrated in FIG. 15, the processed surface 711 is processed so that the processed surface 711 is shaped according to the shape of a surface of the electroformed shell 6. Next, the processed surface 711 is bonded to the rear surface of the electroformed shell 6 with an adhesive agent containing an epoxy resin and aluminum powder.

Next, the master 5 is demolded from the electroformed shell 1. Subsequently, the electroformed shell 6, which is backed with the backing member 71, is installed as a core in a cavity 720 between the upper-mold 721 and the lower-mold 722. Then, the pipe member 741 is inserted into the hole 740 of the backing member 71 to thereby form the media conveying path 74. Also, the threaded portion 742 provided at an end of the pipe member 741 is screwed into the threaded portion 11 of the connecting hole 110 of the connecting jig 1. Thus, the electroformed mold 7 according to the present embodiment is obtained.

The electroformed mold 7 is used in, for example, the injection molding of a thin resin product 3, as illustrated in FIGS. 1 and 2. First, water vapor having a temperature of 120° C. to 170° C. is circulated in the media flow path 2 through the media conveying path 74. Also, similar high-temperature water vapor is circulated in the pipe members 75 embedded in the backing member 71, the upper-mold 721, and the lower-mold 722. Thus, several tens of seconds later, the molding surface 60 reaches a temperature that is nearly equal to the temperature of the water vapor. Subsequently, resin is injected from a nozzle 70 opened in the molding surface 60. Because the electroformed mold 7 is heated by the water vapor to a high temperature, the injected resin smoothly flows in a molding hole 600 surrounded by the molding surface 60. Thus, the molding hole 600 is filled with the resin. Upon completion of the injection of resin, cooling water is supplied into the media flow path 2 and the pipe members 75, instead of the water vapor. Then, several tens of seconds later, the molding surface 60 is cooled to a temperature that is nearly equal to the temperature of the cooling water. Thus, the resin in the molding hole is cooled and solidified. Subsequently, the mold is opened, and a resin product 3 is taken out therefrom.

As illustrated in FIGS. 1 and 2, in the present embodiment, the media flow path 2 in the electroformed shell 6, and the media conveying path 74 formed of the pipe members 741 embedded in the backing member 71 are connected by the connecting jig 1 to each other. The connecting jig 1 is embedded in the electroformed shell 6 and has the opening hole 120 which is opened in the media flow path 2 and has a radial cross-section whose shape is substantially the same as that of a radial cross-section of the media flow path 2. Thus, the media flow path 2 and the connecting jig 1 are continuously covered with the electroformed shell 6. Consequently, the connecting jig 1 is surely connected to the media flow path 2. Because the connecting hole 110 has a radial cross-section whose shape is substantially the same as that of a radial cross-section of the media conveying pipe member 741, the pipe member 741 can be connected to the connecting hole 110 without gap. Accordingly, the media flow path 2 can be surely connected to the media flow path 74 by the connecting jig 1. Consequently, no heat medium leaks out of the media conveying path 74.

Also, the side surfaces 12, 13 of the connecting jig 1 are formed to have a non-undercut shape with respect to the bottom surface 16. Thus, the deposition of the electroformed layer to the side surfaces 12, 13 is enhanced. Consequently, reduction in the thickness of the electroformed layer can be suppressed. Additionally, because the first thermally conductive layer 62 and the connecting jig 1 are continuously covered with the second thermally conductive layer 63 and the reinforcing layer 64, the connecting jig 1 can surely be fixed to the first thermally conductive layer 62.

Similarly to the connecting jig 1, the media flow path 2 has a non-undercut shape. Thus, the deposition of the electroformed metal to the boundary portion between the side surface of the media flow path 2 and the first thermally conductive layer 62 serving as the bottom surface thereof is enhanced. Thus, the media flow path 2 and the first thermally conductive layer 62 are continuously covered with the second thermally conductive layer 63 and the reinforcing layer 64, which are electroformed layers, so that the media flow path 2 and the first thermally conductive layer 62 are surely connected to each other.

Also, electroforming processing is performed on the surfaces of the flow path formation member 4 and the connecting jig 1 in a state in which the end portion 41 of the flow path formation member 4 for forming the media flow path is inserted into the opening hole 120 of the connecting jig 1, and in which the connecting hole 110 of the connecting jig 1 is sealed with the screw 15. Thus, the flow path formation member 4 and the connecting jig 1 are surely connected to each other by the second thermally conductive layer 63 and the reinforcing layer 64, which include an electroformed metal. Additionally, the connecting hole 110 of the connecting jig 1 is sealed with the screw 15. Consequently, no electroformed metal is deposited in the connecting jig 1.

Because the head portion 152 of the screw 15 is covered with the wax sheet 18, no electroformed meal is deposited on the head portion 152 of the screw 15. Therefore, the screw 15 can easily be removed from the connecting hole 110. Consequently, the connecting jig 1 can be easily and surely provided on the media flow path 2.

As illustrated in FIGS. 4 and 7, the media flow path 2 is formed by disposing the soluble flow path formation member 4 between the first thermally conductive layer 62 and the second thermally conductive layer 63 and by subsequently eluting the flow path formation member 4. The flow path formation member 4 is flexibly bent and curved. Thus, even in a case where the flow path formation member 4 is disposed on a step-like portion 601, no gap is formed between the flow path formation member 4 and the step-like portion 601. Additionally, a curved portion having small curvature can be formed in the flow path formation member. Thus, the pitch of the flow path formation members can be reduced. Accordingly, the media flow path 2 can be formed into a meandering shape, in which straight parts of the media flow path 2 are disposed at a narrow pitch, by bending the media flow path 2 at curved parts 25.

Incidentally, in the present embodiment, the preliminarily formed backing member is bonded to the electroformed layer using the adhesive agent. However, the backing member can be formed injecting the backing material, which is obtained by mixing the epoxy resin material functioning as a heat resistant resin with the aluminum powder, to the rear surface side of the electroformed layer.

The electroformed mold according to the invention can be used for molding resin components, for example, vehicle components and home electric appliances.

### Embodiment 2

The electroformed shell formed in the electroformed mold according to the invention has the molding layer whose surface serves as the molding surface, the temperature adjustment portion in which the media flow path is formed between the first and second thermally conductive layers, and the reinforcing layer formed opposite to the molding layer.

The molding layer, the first thermally conductive layer, the second thermally conductive layer, and the reinforcing layer are formed by electroforming processing. When electroforming processing is performed, a target metal is deposited on a transfer surface of the master by utilizing an electrochemical reaction and passing electric current through an electrolyte solution containing metal ions.

The first and second thermally conductive layers are made of the same material. The first and second thermally conductive layers can be made of highly thermally conductive materials including Cu and Al.

Preferably, the thicknesses of the first and second thermally conductive layers range from 3 mm to 5 mm. In a case where the thicknesses of the first and second thermally conductive layers are less than 3 mm, there is a fear that the media flow path may be deformed by the pressure (e.g., an injection pressure) of the molding material. In a case where the thicknesses of the first and second thermally conductive layers exceed 5 mm, electroforming processing takes too much time. Preferably, the first and second thermally conductive layers have the same thickness so as to balance the thermal expansion of the electroformed shell.

There is a tendency that when electroforming processing is performed on the non-flat surface, the electroformed film deposited on the concave portion is thin, as compared with the film deposited on the convex portion. Even in this case, preferably, the thickness of the thinnest portion of each of the first and second thermally conductive layers ranges from 3 mm to 5 mm.

Preferably, the reinforcing layer has a thermal expansion coefficient substantially equal to that of the molding layer. In this case, the thermal expansion difference between the molding layer and the temperature adjustment portion is substantially approximated to that between the reinforcing layer and the temperature adjustment portion. Accordingly, the thermal expansion difference is balanced between both sides of the temperature adjustment portion. Consequently, the deformation of the electroformed shell is suppressed.

The molding layer is a layer that faces the molding surface in the electroformed shell. Preferably, the molding layer is made of Ni whose transfer rate is good. Alternatively, the molding layer can be made of Fe or Cr. The reinforcing layer is made of a material that is the same as that of the molding layer, for example, Ni, Fe, or Cr.

Preferably, the thicknesses of the molding layer and the reinforcing layer range from 2 mm to 5 mm. In a case where the thicknesses of the molding layer and the reinforcing layer are less than 2 mm, the stiffness of the media flow path is low. Thus, there is a fear that the media flow path may be deformed by the pressure of the molding material (e.g., the injection pressure). In a case where the thicknesses of the molding layer and the reinforcing layer exceed 5 mm, electroforming processing takes too much time. Preferably, even in a case where the film thicknesses of the molding layer and the reinforcing layer are not uniform, the thickness of the thinnest portion of each of the molding layer and the reinforcing layer ranges from 3 mm to 5 mm. Preferably, the first and second thermally conductive layers have nearly equal thicknesses so as to balance the thermal expansion of the electroformed shell.

A media flow path for temperature adjustment is formed between the first and second thermally conductive layers. The media flow path is provided by being bent substantially in parallel to the molding surface of the electroformed shell into a meandering shape. Preferably, the medial flow path is cross-sectionally formed into a non undercut shape in which an angle formed between a side surface of the flow path formation member and a surface of the electroformed shell is equal to or more than 90°. In this case, electroformed metal is easily deposited on the boundary between the media flow path and the first thermally conductive layer, as compared with a case where the medial flow path is cross-sectionally formed into an undercut shape. Examples of the non-undercut shape are a semicircle, a rectangle, and a trapezoid.

Preferably, the width of the media flow path ranges 5 mm to 15 mm. In a case where the width of the media flow path is less than 5 mm, there is a fear that the adjustment of temperature of the media flow path cannot quickly be achieved. In a case where the width of the media flow path exceeds 15 mm, there is a fear that the strength of the media flow path may be reduced.

When the media flow path is formed, a flow path formation member having micro pores in a surface thereof is used. Preferably, the flow path formation member is made of a material that can flexibly be bent or curved. The flow path formation member can be constituted either by using a monofilament made of such a material or by knitting a plurality of filaments made of such a material. The flow path formation member is formed by using a material soluble in a solvent or by using a material that is molten by being heated. Such a material is, for example, polystyrene or wax.

Preferably, in consideration of the deposition of the electroformed metal, the cross-sectional shape of the boundary portion between the thermally conductive layer and the flow path formation member disposed on the thermally conductive layer is a non undercut shape, such as a semicircle (see FIG. 9), a rectangle (see FIG. 10A), a square, and a trapezoid (see FIG. 10B). In a case where micro pores are formed in a surface of the flow path formation member, a material, such as polystyrene, containing micro pores in itself is used as the material of the flow path formation member.

An electrical conductive treatment is performed on the flow path formation member so as to form an electroformed shell on a surface of the flow path formation member. The electrical conductive treatment is, for example, to apply silver paste, which is obtained by dispersing silver powder in binder, onto the surface of the flow path formation member or to perform a silver mirror process of depositing silver by a silver mirror reaction.

The backing member, with which the electroformed shell is backed, is shaped according to the shape of the rear surface of the electroformed shell and is provided on the rear surface thereof. The material of the backing member is, for example, a metallic material, such as a heat resistant resin, a cement, or aluminum, which can include an electrically conductive material, such as aluminum powder, fibers, such as a carbon fiber, and a reinforcing material, such as a sheet.

A backing surface of the backing member, with which the electroformed shell is backed, can be formed by, for example, electrical-discharging. The electroformed shell is backed with the backing member by applying an adhesive agent onto the backing surface, on which the electrical discharging is performed, to thereby bond the backing member to the electroformed shell. Alternatively, the electroformed shell can be backed with the backing member by pouring the molten material of the backing member onto a surface opposite to the molding surface of the electroformed shell.

The electroformed mold can freely adjust the temperature thereof by circulating a heat medium in the media flow path. Thus, the electroformed mold is used suitably for molding products having various shapes, such as a thin shape, an elongated shape, and a fine design-surface shape, and for preventing the formation of weld marks and sink marks.

An embodiment 2 of the invention is described below with reference to the accompanying drawings.

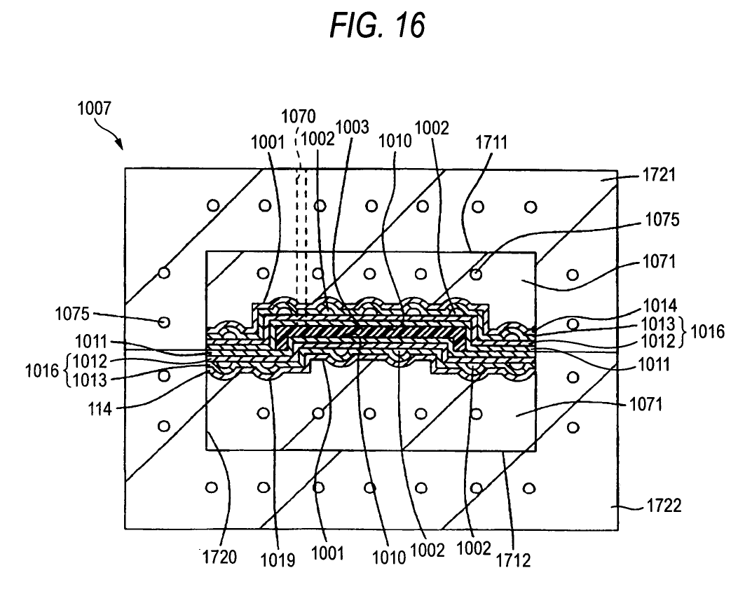

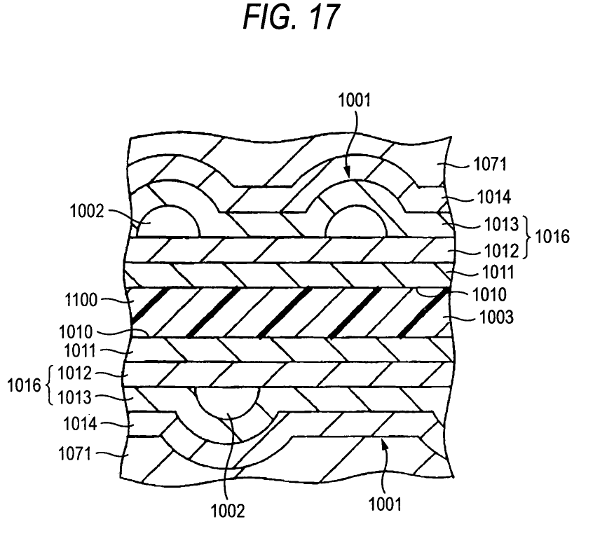

As illustrated in FIGS. 16 and 17, an electroformed mold 1007 according to the present embodiment includes an electroformed shell 100 that has a molding surface 1010 and that is formed by electroforming processing, a backing member 1071 with which the electroformed shell 1001 is backed, and a media flow path 1002 that is formed in the electroformed shell 1001 and circulates a heat medium so as to adjust the temperature of the molding surface 1010. The electroformed shell 1001 includes a molding layer 1011 whose surface serves as the molding surface 1010, a temperature adjustment portion 1016 configured so that the media flow path is formed between a first thermally conductive layer 1012 and a second thermally conductive layer 1013, which are made of the same material, and a reinforcing layer 1014 formed opposite to the molding layer 1011 across the temperature adjustment portion 1016.

The first thermally conductive layer 1012 and the second thermally conductive layer 1013 are electroformed layers made of Cu having good thermal conductivity. Both of the molding layer 1011 and the reinforcing layer 1014 are electroformed layers made of Ni having high stiffness and transfer rate. The thicknesses of the molding layer 1011, the first thermally conductive layer 1012, the second thermally conductive layer 1013, and the reinforcing layer 1014 are 3 mm, 4 mm, 4 mm, and 3 mm, respectively. The shape of a cross-section of the media flow path 1002 is a semicircle. The diameter of the cross-section of the media flow path 1002 is 8 mm. The backing member 1071 is made of aluminum and is bonded to the electroformed shell 1001 with an adhesive agent obtained by mixing an epoxy resin material, which is a heat resistant resin, and aluminum powder.

The electroformed mold 1007 has an upper-mold 1721 and a lower mold 1722. A cavity 1720 is formed between the upper-mold 1721 and the lower-mold 1722. The electroformed shell 1001 and the backing member 1071 are provided in the cavity 1720 as cores. Metallic pipes 1075 for circulating temperature adjustment heat media are embedded in each of the upper-mold 1721, the lower-mold 1722, and the backing member 1071.

Next, a manufacturing method for an electroformed mold is described below.

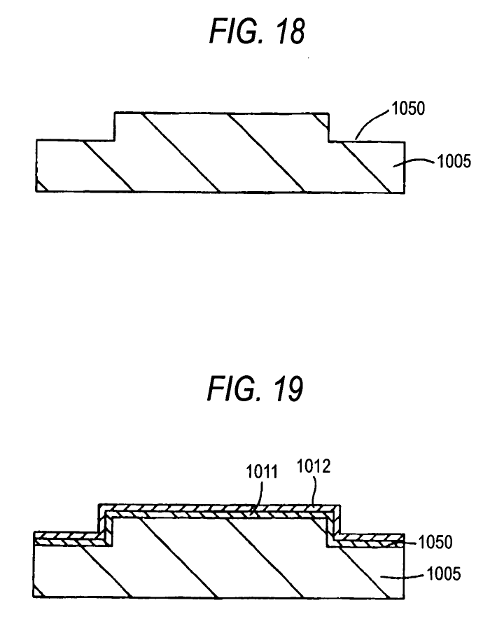

First, as illustrated in FIG. 18, a master 1005 having a transfer surface 1050 shaped according to the shape of the molding surface 1010 is prepared. The master 1005 is made of an epoxy resin material to which electrical conductivity is imparted. As illustrated in FIG. 19, by performing electroforming processing on the master 1005, the molding layer 1011 and the first thermally conductive layer 1012 are sequentially formed. By immersing the master 1005 in an electrolyte solution containing Ni-ions and Cu-ions and also feeding electric current to the solution Electroforming processing is performed. Thus, target metal is deposited on the transfer surface 1050. Consequently, the molding layer 1011 made of Ni and the thermally conductive layer 1012 that is made of Cu are sequentially deposited.

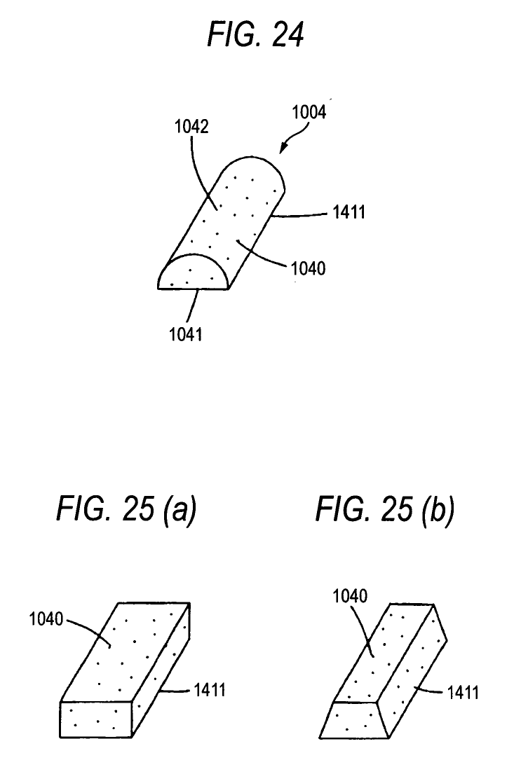

Next, as illustrated in FIG. 24, the flow path formation member 1004 for forming a media flow path, which has micro pores 1040 formed in the surface, is prepared. A cross-sectionally semicircular-shaped monofilament, which is 8 mm in diameter and is made of polystyrene, is used as the flow path formation member 1004. Silver paste obtained by dispersing silver powder in binder is applied to the flow path formation member 1004. Thus, electrical conductivity is imparted to a surface of the flow path formation member 1004.

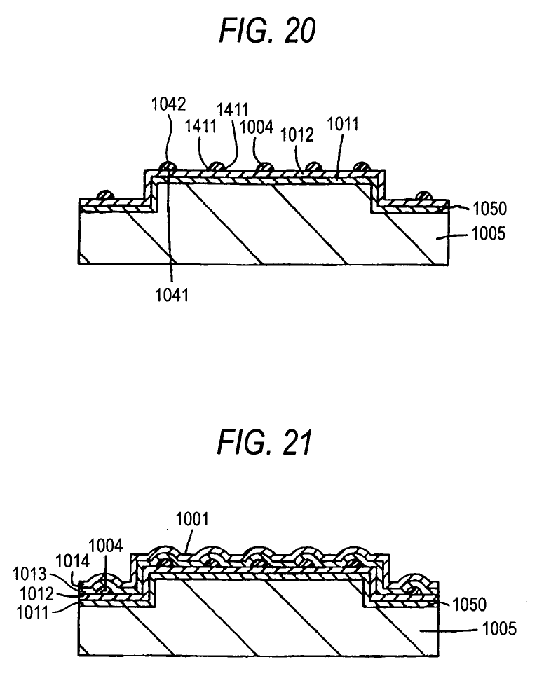

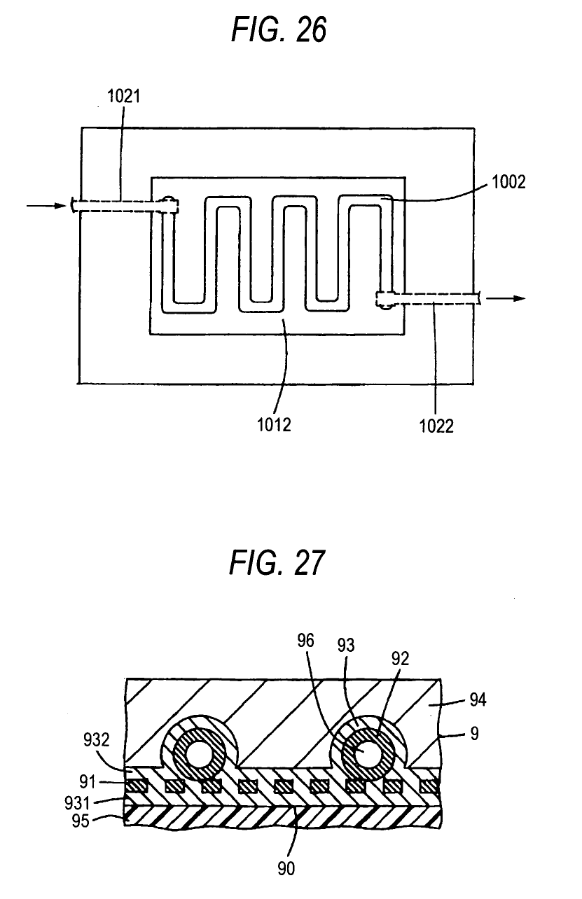

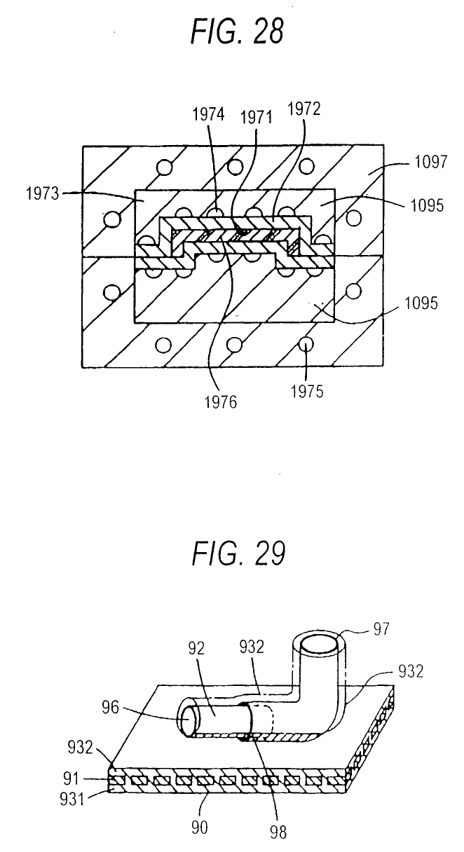

Next, as illustrated in FIG. 20, the flow path formation member 1004 is disposed on the first thermally conductive layer 1012. The flow path formation member 4 is cross-sectionally semicircular-shaped. A straight part 1041 of the flow path formation member 1004 is caused to abut against the first thermally conductive layer 1012. A cross-sectionally semicircular-arc-part 1042 is disposed to be directed upwardly. At that time, as illustrated in FIG. 26, the flow path formation member 1004 is disposed on the entire first thermally conductive layer 1012 in a meandering shape so that the straight parts are placed at predetermined intervals.

Next, as illustrated in FIG. 21, the second thermally conductive layer 1013 made of Cu and the reinforcing layer 1014 made of Ni are sequentially formed on the first thermally conductive layer 1012, on which the flow path formation member 1004 is disposed, by performing electroforming processing. The flow path formation member 1004 is coated with the silver paste and has electrical conductivity. Accordingly, electroformed metal is deposited on a surface of the flow path formation member 1004. Consequently, the second thermally conductive layer 1013 and the reinforcing layer 1014 are formed. Thus, the electroformed shell 1001 including the molding layer 1011, the first thermally conductive layer 1012, the second thermally conductive layer 1013, and the reinforcing layer 1014 is formed on a surface of the master 1005. Subsequently, the flow path formation member 1004 is eluted with a solvent. Thus, the media flow path 1002 is formed. Subsequently, as illustrated in FIG. 26, an inflow tube 1021 and an outflow tube 1022 are connected to an upstream-side end portion and a downstream-side end portion of the media flow path 1002, respectively.

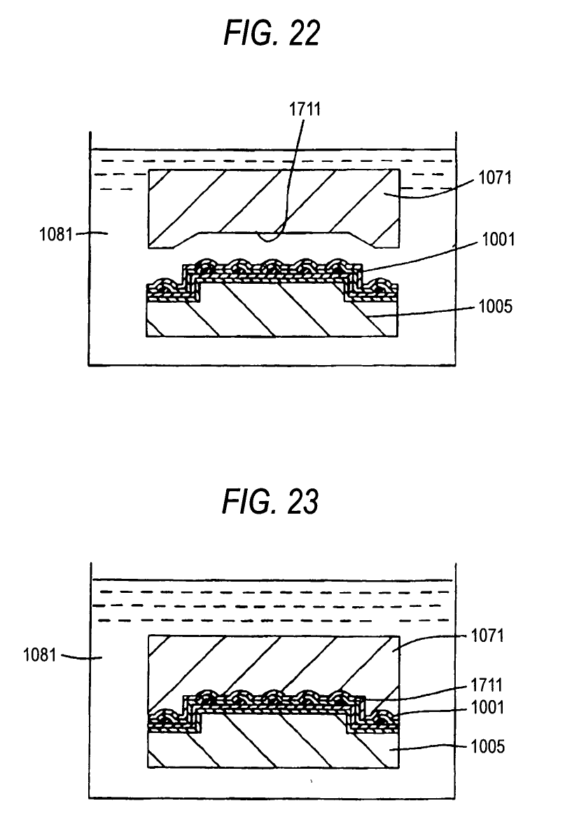

Next, as illustrated in FIG. 22, surface processing (e.g., cutting processing) is performed on the surface of the backing member 1071 made of aluminum so that the surface of the backing member 1071 approximately corresponds to the shape of the surface of the electroformed shell 1001. Subsequently, the distance between the processed surface 1711 and the electroformed shell 1001 is gradually decreased. Then, an electric discharge occurs between the electroformed shell 1001 and the processed surface 1711. Thereafter, as illustrated in FIG. 23, the processed surface 1711 is further processed so that the processed surface 1711 is shaped according to the shape of a surface of the electroformed shell 1001. Next, the processed surface 1711 is bonded to the surface of the electroformed shell 1001 with an adhesive agent obtained by mixing an epoxy resin with aluminum powder. Then, the master 1005 is demolded from the electroformed shell 1001. Thereafter, the electroformed shell 1001, which is backed with the backing member 1001, is installed as a core in a cavity 1720 between the upper-mold 1721 and the lower-mold 1722. Thus, the electroformed mold 1007 according to the present embodiment is obtained.

The electroformed mold 1007 is used in, for example, the injection molding of a thin resin product 1003, as illustrated in FIG. 16. First, water vapor having a temperature of 120° C. to 170° C. is circulated in the media flow path 1002 and pipes 1075. Several tens of seconds later, the molding surface 1010 reaches a temperature that is nearly equal to the temperature of the water vapor. Subsequently, resin is injected from a nozzle 1070 opened in the molding surface 1010. Because the electroformed mold 1007 is heated by the water vapor to a high temperature, the injected resin smoothly flows in a molding hole 1100 surrounded by the molding surface 1010. Thus, the molding hole 1100 is filled with the resin. Upon completion of the injection of resin, cooling water is supplied into the media flow path 1002 and the pipes 1075, instead of the water vapor. Then, the molding surface 1010 is cooled to a temperature that is nearly equal to the temperature of the cooling water. Thus, the resin in the molding hole is cooled and solidified. Subsequently, the mold is opened, and a resin product 1003 is taken out therefrom.

In the present embodiment, the media flow path 1002 is formed between the first thermally conductive layer 1012 and the second thermally conductive layer 1013. The first thermally conductive layer 1012 and the second thermally conductive layer 1013 are made of the same material formed of Cu. Thus, the first thermally conductive layer 1012 and the second thermally conductive layer 1013 are firmly and closely attached to each other. Accordingly, the airtightness of the media flow path 1002 is held between the first thermally conductive layer 1012 and the second thermally conductive layer 1013. Because the media flow path 1002 is enclosed by the first thermally conductive layer 1012 and the second thermally conductive layer 1013, the temperature of a medium can quickly be transmitted to the molding surface 1010.

A rib 1019 extending along the length direction of the media flow path 1002 is formed at a part at the side of the backing member 1071 in a portion in which the media flow path 1002 of the electroformed shell 1001. The stiffness of the entire electroformed shell is further enhanced by the rib 1019.

The reinforcing layer 1014 is formed opposite to the molding layer 1011 across the temperature adjustment portion 1016. Thus, the temperature adjustment portion 1016 is reinforced, so that the stiffness of the entire electroformed shell 1001 can be assured.

The reinforcing layer 1014 is made of a Ni-material, which is the same as the material of the molding layer 1011. Thus, the temperature adjustment portion 1016 is sandwiched between the layers made of the same material. Consequently, the difference in thermal expansion between the molding layer 1011 and the temperature adjustment portion 1016 is nearly approximated to that in thermal expansion between the reinforcing layer 1014 and the temperature adjustment portion 1016. Accordingly, the thermal expansion difference is balanced between both sides of the temperature adjustment portion. Consequently, the deformation of the electroformed shell 1001 is suppressed.

When the media flow path is formed, a flexibly bendable flow path formation member 1004 is used. Thus, the flow path formation member 1004 can be disposed in a free shape. Consequently, the flow path formation member 1004 can be bent at small curvature so that the straight parts thereof can be disposed at small pitches. Even when the flow path formation member 1004 is disposed at a step-like portion, no gap is formed between the flow path formation member 1004 and the step-like portion. Accordingly, the media flow path 1002 can be formed in a free shape so that the straight parts thereof are formed in a free shape at high density.

The flow path formation member 1004 is made of polystyrene. Plural micro pores 1040 are formed therein. Thus, a silver paste enters a surface portion of the flow path formation member 1004. Consequently, the anchoring effect is exerted. Consequently, electrically conductivity can be imparted to the entire surface of the flow path formation member 1004.

The flow path formation member 1004 has a cross-sectionally semicircular arc portion 1042. Thus, when the flow path formation member 1004 is disposed in the first thermally conductive layer 1012, a non-undercut portion 1411, in which an angle formed between the circular-arc side surface of the flow path formation member 1004 and the surface of the first thermally conductive layer 1012 is equal to or more than 90°, is formed in the flow path formation member 1004. Accordingly, as compared with a case where the flow path formation member 1004 has an undercut portion, in which the angle formed therebetween is less than 90°, the deposition of the electroformed metal on a part between the electroformed path member 1004 and the can be enhanced.

In the present embodiment, a preliminarily formed backing member is attached to an electroformed layer with an adhesive agent. However, the backing member can be formed by injecting the material of the backing member obtained by mixing an epoxy resin material, which is a heat resistant material, and aluminum powder to the rear surface side of the electroformed layer.

The electroformed mold according to the invention can be used for molding resin components, for example, vehicle components and home electric appliances.

What is claimed is:

1. An electroformed mold, comprising:
an electroformed shell, having a molding surface and formed by electroforming processing;
a media flow path, circulating a heat medium so as to perform temperature adjustment on the molding surface formed in the electroformed shell;
a backing member, with which the electroformed shell is backed; and
a media conveying path, provided outside the electroformed shell and flowing a heat medium into or out of the media flow path;
wherein a connecting jig for connecting the media flow path and the media conveying path is embedded in the electroformed shell;
the connecting jig includes:
a cavity portion formed therein;
an opening hole exposed from the electroformed shell, having a cross-sectional shape which is substantially same as a shape of a radially cross-section of the media flow path; and
a connecting hole having a cross-sectional shape that is substantially same as a shape of an outside diametrical cross-section of a pipe member constituting the media conveying path; and
wherein the opening hole and the connecting hole are communicated with each other through the cavity portion.

2. The electroformed mold according to claim 1, wherein the connecting jig is provided at least at one of an upstream-side end portion and a lower-stream side end portion of the media flow path.

3. The electroformed mold according to claim 1, wherein an outer shape of the connecting jig is a non-undercut shape with respect to a bottom surface thereof.

4. The electroformed mold according to claim 1, wherein an outer shape of the media flow path is a non-undercut shape with respect to a bottom surface thereof.

5. A manufacturing method for an electroformed mold having:
an electroformed shell, having a molding surface and formed by electroforming processing;
a media flow path, circulating a heat medium so as to perform temperature adjustment on the molding surface formed in the electroformed shell;
a backing member, with which the electroformed shell is backed; and
a media conveying path, provided outside the electroformed shell and flowing a heat medium into or out of the media flow path, the manufacturing method, comprising:
a first electroforming step of forming an electroformed layer on a transfer surface of a master, the transfer surface being shaped according to a shape of the molding surface;
a providing step of providing on a surface of the electroformed layer a flow path formation member for forming the media flow path, on which an electrical conductive treatment is performed, and a connecting jig including an opening hole in which the flow path formation member is inserted, a connecting hole, sealed with a sealer, for connecting the media conveying path, and a cavity portion for communicating the opening hole with the connecting hole;
a second electroforming step of further forming on a surface of the electroformed layer on which the flow path formation member and the connecting jig are provided, an electroforming layer; and
an eluting step of eluting the flow path formation member from the electroformed layer and of forming the media flow path.

6. The manufacturing method for an electroformed mold according to claim 5, wherein an exposure portion of the sealer, which is exposed from the connecting hole, is covered with a non-electroforming material.

7. An electroformed mold having an electroformed shell that has a molding surface and that is formed by electroforming processing, a backing member with which the electroformed shell is backed, and a media flow path that is formed in the electroformed shell and circulates a heat medium so as to adjust the temperature of the molding surface,
wherein the electroformed shell includes:
a molding layer whose surface serves as the molding surface;
a temperature adjustment portion configured so that the media flow path is formed between a first thermally conductive layer and a second thermally conductive layer that are made of a same material; and
a reinforcing layer formed to face the molding layer across the temperature adjustment portion.

8. The electroformed mold according to claim 7, wherein the reinforcing layer is made of a same material as that of the molding layer.

9. The electroformed mold according to claim 7, wherein the first thermally conductive layer and the second thermally conductive layer are made of Cu.

10. The electroformed mold according to claim 7, wherein the reinforcing layer and the molding layer are made of Ni.

11. A manufacturing method for an electroformed mold including an electroformed shell having a molding surface, a media flow path being formed in the electroformed shell to circulate a heat medium for temperature adjustment, the manufacturing method, comprising:
sequentially depositing a molding layer and a thermally conductive layer by performing electroforming processing on a transfer surface of a master, the transfer surface being shaped according to a shape of the molding surface;
providing a flow path formation member, on which electrically conducting processing is performed, for forming a media flow path on a surface of the thermally conductive layer;
forming an electroformed shell by depositing a thermally conductive layer and a reinforcing layer through further electroforming processing on a surface of the thermally conductive layer; and
forming the media flow path by removing the flow path formation member from the electroformed shell.

12. The manufacturing method for an electroformed mold according to claim 11, wherein the flow path formation member is made of polystyrene.

13. The manufacturing method for an electroformed mold according to claim 11, wherein the flow path formation member has micro pores provided in a surface thereof.

14. The manufacturing method for an electroformed mold according to claim 11, wherein the flow path formation member has a non undercut shape in which an angle formed between a side surface of the flow path formation member and a surface of the electroformed shell is equal to or more than 90° when the flow path formation member is provided on the electroformed shell.
